(19) United States
(12) Patent Application Publication
(10) Pub. No.: US 2007/0040911 A1
(43) Pub. Date: Feb. 22, 2007

(54) Under vehicle inspection system

(76) Inventor: Larry E. Riley, Fritz Creek, AL (US)

Correspondence Address: VOLENTINE FRANCOS, & WHITT PLLC, ONE FREEDOM SQUARE, 11951 FREEDOM DRIVE SUITE 1260, RESTON, VA, 20190, US

(21) Appl. No.: 11/585,263

(22) Filed: Oct. 24, 2006

Related U.S. Application Data
(63) Continuation-in-part of application No. 11/389,182, filed on Mar. 27, 2006.
Application No. 11/389,182 is a continuation-in-part of application No. 11/045,074, filed on Jan. 31, 2005.

(51) Int. Cl. H04N 7/18

(52) U.S. Cl. 348/148; 348/159

(57) ABSTRACT

An under vehicle inspection system comprises a single camera adapted to capture a full width image of a vehicle undercarriage in a single scan. The camera has a viewing distance from the vehicle undercarriage, as measured along the optical axis of the camera, that is greater than a Euclidean distance between the camera and a point where the optical axis meets the vehicle undercarriage.

### CROSS REFERENCE TO RELATED APPLICATIONS

This application is a continuation-in-part of U.S. patent application Ser. No. 11/389,182 filed Mar. 27, 2006 (the '182 application), which is a continuation-in-part of U.S. patent application Ser. No. 11/045,074 filed on Jan. 31, 2005 (the '074 Application), the respective disclosures of which are hereby incorporated by reference in their entirety.

### STATEMENT OF GOVERNMENT SPONSORED RESEARCH

One or more agencies of the United States Government have a paid-up license in this invention and may in limited circumstances possess the right to require the patent owner to license others on reasonable terms as provided by the terms of Government Contract Number N00164-04-C-6653 awarded by the Naval Surface Warfare Center, Crane, Ind.

### BACKGROUND OF THE INVENTION

1. Field of the Invention

Embodiments of the invention relate generally to an under vehicle inspection system. More particularly, embodiments of the invention relate to an under vehicle inspection system and related methods of vehicle inspection.

2. Description of Related Art

Criminals and terrorists have been known to transport drugs, explosives, stolen goods, and other forms of contraband in the undercarriages of vehicles. The term “undercarriage” here refers to all or part of the underside of a vehicle, including various nooks and crannies such as the wheel wells and areas between engine parts. The term “vehicle” specifically includes at least automobiles, vans, small trucks, construction equipment, and large trucks, such as so-called 18-wheelers as well as associated trailers and other towed assemblies.

Inspection stations have traditionally been set up in a variety of locations to prevent the passage of forbidden or unwanted items hidden in the undercarriage of vehicles. For example, international and state border crossings, airports, military and security checkpoints, and even many commercial structures are protected by systems designed to inspect vehicle undercarriages.

Perhaps the most common conventional method used to perform under vehicle inspections involves a human inspector manipulating a mirror attached to the end of a stick. The inspector manually positions the mirror underneath a vehicle in such a way that he or she can view portions of the vehicle's underside in the mirror's reflection. This allows the inspector to examine the vehicle's underside without having to kneel down or crawl underneath the vehicle.

The so called “mirror on a stick” approach has a number of fairly obvious shortcomings. Most notably, this approach puts the inspector in physical danger by placing him or her near potentially harmful substances, e.g. explosives, caustic chemicals, biological weapons, etc. Furthermore, scanning the entire underside of a vehicle using a mirror on a stick takes a considerable amount of time, which typically leads to serious congestion in high traffic areas. Moreover, human inspectors often fail to notice important details when they are fatigued or in a rush, thereby limiting the reliability of their inspections.

A number of more sophisticated approaches have been proposed in an attempt to provide safer, more efficient, and more reliable ways of inspecting vehicle undercarriages. These approaches include, for example, stationary under vehicle inspection devices and unmanned robotic vehicles.

Conventional stationary under vehicle inspection devices are characterized by the use of fixed (e.g., unmoving) cameras that image some portion of a vehicle's undercarriage as the vehicle is driven over the device. A typical stationary under vehicle inspection device comprises a camera strip that captures a number of images of the vehicle's underside and then sends the images to a human inspector for analysis. An example of a stationary under vehicle inspection device is disclosed in U.S. Patent Application Publication No. 2003/0185340.

Unmanned ground vehicles (UGVs), or mobile robotic vehicles are also used to image the underside of a vehicle by moving around underneath the vehicle. Typically, an UGV comprises a semi-autonomous unit having a video camera and a transmitter. The UGV takes images of the vehicle's underside as it moves around and sends the images to a human inspector for analysis.

Stationary under vehicle inspection devices and UGVs each have some major problems. For example, stationary under vehicle inspection devices generally produce very poor quality (e.g., blurry) images due to the fact that the vehicles driven over these devices often travel at inconsistent speeds and impart significant mechanical vibration to the imaging device as they pass over the inspection point. Furthermore, cameras fixed in stationary under vehicle inspection devices are generally incapable of selectively focusing in on suspicious areas of the undercarriage or adjusting their imaging view around a difficult angle. As such, conventional stationary under vehicle inspection devices are unable to inspect areas such as wheel wells, which are a common place for stowing illegal items.

UGVs, on the other hand, experience poor and inconsistent image quality due to frequent image transmission failures caused by the mobile unit losing line of sight with a receiver station or due to radio frequency interference, and also due to image blur and jitter resulting from the motion of the UGV In addition, because UGVs have a fixed size, they cannot adapt to the varying heights of vehicle undercarriages, and therefore cannot accommodate the low ground clearance, e.g., of vehicles that are missing their shocks, etc. Another problem with UGVs is that they have trouble moving around on poor or uneven surfaces such as mud or gravel. Furthermore, inspections made by UGVs are usually random, as the mobile robot moves around selected areas of the vehicle undercarriage rather than uniformly scanning the entire structure. Finally, as with stationary under vehicle scanners, UGVs are unable to inspect most wheel wells because their available view angles are often obstructed by vehicle wheels and other vehicle parts.

In addition, some problems that are common to both stationary under vehicle inspection devices and UGVs include a tendency to be adversely affected by environmental conditions such as debris and changing weather, and an inability maintain a precise spatial relationship with a vehicle's undercarriage. The first problem may occur, for example, where substances such as dirt or mud come in contact with these devices' optical, mechanical, or electrical components, or where the air temperature causes temperature sensitive components such as digital image sensors to perform sub-optimally. The second problem tends to occur in stationary under vehicle inspection devices due to their inability to precisely track a vehicle's position, e.g., due to the vehicle's inconsistent speed, elevation, etc., and it occurs in UGVs due to their inability to precisely track their own position, e.g., because they may be moving around on uneven or unpredictable surfaces. The tendency to be adversely affected by environmental conditions increases the maintenance cost and decreases the reliability of these technologies, and the inability to maintain a precise spatial relationship with the vehicle's undercarriage tends to complicate the image capture and analysis process.

Due to these and other manifest limitations in the proposed approaches, the “mirror on a stick” method remained until recently the most reliable form of under vehicle inspection. Given the great risk that this method presents to inspection personnel, however, the mirror on a stick approach is unacceptable.

What is needed, therefore, is a system which is at least as reliable as the mirror on a stick approach, yet which provides a safe and efficient way of inspecting the undercarriages of vehicles.

### SUMMARY OF THE INVENTION

Embodiments of the invention provide an under vehicle inspection system capable of reliably and efficiently detecting suspicious articles in the undercarriages of vehicles while minimizing the risk of physical harm to inspection personnel. In one embodiment of the invention, a full width image of a vehicle's undercarriage is captured in a single scan along the length of the undercarriage. The image is preferably captured using a single camera in a camera carriage moving along a smooth track on a transportable vehicle undercarriage inspection platform.

According to one embodiment of the invention, an under vehicle inspection system comprises a single camera adapted to capture a full width image of a vehicle undercarriage in a single scan. The camera has a viewing distance from the vehicle undercarriage, as measured along the optical axis of the camera, that is greater than a Euclidean distance between the camera and a point where the optical axis meets the vehicle undercarriage.

According to another embodiment of the invention, an undercarriage inspection platform for an under vehicle inspection system comprises a tongue assembly, a scanning platform, and a wheel/axel assembly. The scanning platform comprises a camera carriage track adapted to support a camera carriage such that the camera carriage can move along the length of a vehicle to perform an under vehicle inspection. The wheel/axel assembly comprises a frame, wheels, and axels and adapted to be connected to the tongue assembly and scanning platform during transportation and detached from the tongue assembly and scanning platform so that the scanning platform can lay on the ground during under vehicle inspections.

According to another embodiment of the invention, a method of inspecting the undercarriage of a vehicle comprises moving a single camera along the length of the vehicle to capture a single full width image of the undercarriage. The camera has a viewing distance from the undercarriage, as measured along the optical axis of the camera, that is greater than a Euclidean distance between the camera and a point where the optical axis meets the undercarriage.

### BRIEF DESCRIPTION OF THE DRAWINGS

Embodiments of the invention are described in relation to the accompanying drawings. Throughout the drawings like reference numbers indicate like exemplary elements, components, or steps. In the drawings:

(FIG.) 1 is a conceptual diagram of an under vehicle inspection system;

FIG. 2 is a diagram of an under vehicle inspection system including a single camera pointed toward a vehicle undercarriage;

FIG. 3 is a diagram of an under vehicle inspection system including multiple cameras pointed toward a vehicle undercarriage;

FIG. 4 is a diagram of an under vehicle inspection system including a single camera whose optical axis is deflected by a mirror;

FIG. 5 is a diagram of a camera carriage for an under vehicle inspection system;

FIG. 6 is another view of the camera carriage shown in FIG. 5;

FIG. 7 is a diagram of a camera carriage attached to a motor plate;

FIG. 8 is a diagram of a camera carriage mounted on a camera carriage track and below a gear rack;

FIG. 9 is a diagram of an under vehicle inspection platform;

FIG. 10 is a diagram of a wheel/axel assembly of the under vehicle inspection platform;

FIG. 11 is a diagram of a tongue assembly and scanning platform of the under vehicle inspection platform;

FIGS. 12 though 15 are diagrams illustrating a method of placing a scanning platform of the under vehicle inspection platform on the ground in order to perform an under vehicle inspection;

FIGS. 16 and 17 are diagrams of a tongue assembly;

FIG. 18 is a diagram of the scanning platform on the ground with foldable entrance and exit ramps extended;

FIG. 19 is a diagram of a foldable entrance ramp of the scanning platform;

FIGS. 20 through 24 are diagrams illustrating a bumper system for the under carriage inspection platform;

FIG. 25 is a diagram illustrating the scanning platform including a wheel well inspection system;

FIG. 26 is a diagram illustrating an imaging unit used to capture images in the wheel well inspection system;

FIG. 27 is a front view illustrating the wheel well inspection system in further detail; and,

FIG. 28 is a side view illustrating the wheel well inspection system in further detail.

### DESCRIPTION OF EXEMPLARY EMBODIMENTS

Exemplary embodiments of the invention are described below with reference to the corresponding drawings. These embodiments are presented as teaching examples. The actual scope of the invention is defined by the claims that follow.

Selected embodiments of the invention provide an under vehicle inspection system comprising a single camera adapted to capture a full width image of a vehicle undercarriage by performing a single scan, or pass, along the length of the vehicle undercarriage. The camera is typically mounted in a camera carriage adapted to move along the length of the vehicle undercarriage on a track associated with a vehicle undercarriage inspection platform.

The term “vehicle undercarriage inspection platform” (or “platform” for short) is used throughout this description to denote any physical structure capable of receiving and/or supporting a vehicle, in whole or in part, in such a manner that the camera may view a significant portion of the vehicle's undercarriage. That is, one group of embodiments specifically contemplates supporting a stationary vehicle driven up onto the platform. Whereas, another group of embodiments contemplates “receiving” a vehicle positioned, at least in part, over it (e.g., straddling it).

For example, the vehicle undercarriage inspection platform may take the form of a movable or transportable mechanical structure, such as a tow-able trailer or one or more platform sections or pieces (e.g., a collection of welded beam structures). In one specific embodiment, the one or more platform section may be sized for convenient transport by truck and/or aircraft. The vehicle undercarriage inspection platform may take the form of an “in-ground” or “on-ground” structure constructed, for example, from concrete or welded steel.

Various embodiments of the invention provide platforms of varying height, length, and width. Longer platforms may be formed from connected or related sections that may be added or removed according to the nature of a vehicle inspection being performed.

In certain embodiments of the invention, the camera needs not be integrated with, physically connected to, and/or mechanically attached to the platform. However, other embodiments of the invention recognize certain benefits in arrangements where the camera is mechanically associated with the platform, but not necessarily integrated with the platform in manner that would preclude ready replacement of the camera without material movement or deconstruction of the platform.

In selected embodiments, the under vehicle inspection system may comprise more sensors than just the single camera. For example, the under vehicle inspection system could comprise multiple cameras, or other types of sensors, either individually or in combination. Examples of other types of sensors that could be used are disclosed in the '074 and the '182 Applications.

In some embodiments of the invention, the camera and/or other sensors are mounted in a camera carriage adapted to hold the camera and/or related components. The related components may include, for example, power supplies, lights, motors, processing elements such as digital image filters, data transmission/reception hardware, and so on. The camera carriage may serve a variety of purposes, such as providing a convenient mechanism for moving the sensors and/or related components along an under vehicle inspection platform, or protecting the sensors and/or other components from harmful environmental conditions such as debris and adverse weather conditions.

In some embodiments, the camera carriage comprises one or more structures, each adapted to receive and hold the camera and/or related components. In one embodiment, the structure comprises a floor and one or more walls that collectively form a protective enclosure adapted to keep out debris, moisture, and so on. Alternatively, a transparent or partially transparent dome like structure may be mounted on a floor to protect the camera and/or related components.

In some embodiments, the camera carriage will be moved along the length of the platform by an externally applied force or mechanism. For example, the camera carriage may be push/pulled along the length of the platform by a belt, cable, chain, etc., connected to an external drive mechanism such as a motor. Alternatively, the camera carriage may be moved along the length of the platform by an integrated or partially-integrated drive mechanism. For example, the camera carriage may be provided with a set of gears, linkages, wheels, or similar mechanical/electrical components adapted to move the camera carriage along the length of the platform. In either alternative, the camera carriage may be mechanically associated with a track integral to the platform or a track otherwise provided but not integral with the platform.

The camera may comprise either a still camera or a video camera, and may be digital and/or film based in its imaging capabilities. Where a digital camera is used, it may include a charge coupled device (CCD) or complementary metal oxide semiconductor (CMOS) based image sensor, for example.

According to one embodiment of the invention, the camera is a digital line scan camera. The digital line scan camera typically uses a linear array of CCDs to build up a series of single pixel lines, thereby creating a final image. This allows the camera to create an image covering a large area or even the entirety of a vehicle's undercarriage without having to rely on techniques such as stitching together multiple images. In addition, the digital line scan camera provides exceptional resolution and “zoom” capability, thereby allowing the under vehicle inspection system to consider the fine details of a vehicle's undercarriage. In this context, the term “zooming” may refer to an enhancement process performed on digital image data provided by the digital line scan camera (or similar device) by an associated data analysis system either integrally provided within the camera carriage or externally provided, for example, as part of an attached data analysis element.

The camera and the camera carriage will be capable of movement in at least one direction relative to a vehicle undercarriage inspection platform. This direction as referenced above is arbitrarily referred to as the “length” of the platform as it corresponds to the length of the vehicle being imaged or scanned. However, the camera, in association with or independent from the camera carriage, may also be moved vertically, horizontally, angularly, rotationally, or any combination thereof. Where other sensors are included in the under vehicle inspection system, the sensors may be independently moved and/or moved as one or more coordinated pluralities. Furthermore, individual or grouped sensors may perform their respective functions at varying ranges of resolution and/or sensitivity. For example, one or more cameras may zoom in and zoom out on a particular region of an undercarriage, while a chemical detector may simultaneously sample over a broader area.

The term “data analysis element” refers to any system capable of receiving, communicating, storing, and/or evaluating data derived from the camera or other sensors. Data, such as visual image data, is often communicated directly to a human operator via (e.g.,) a monitor. Evaluation of data typically comprises classifying the data as “suspicious” or “not suspicious.” In one embodiment, a human operator may interact with a data analysis element of the system to classify sensor data according to objective and/or subjective criteria. In another embodiment, the data analysis element will comprise a digital logic system receiving digital data from the plurality of sensors and classifying the data using machine learning techniques such as simple template comparisons or more sophisticated approaches including various pattern recognition or data mining techniques, or a simple threshold based system, whereby a predetermined response (e.g. an alarm) is triggered anytime a certain parameter exceeds an allowable threshold.

The data analysis element typically receives data captured by at least one of the sensors through some form of intermediate link connecting the data analysis element with the plurality of sensors. This link may be formed using a hardwire connection or a wireless connection. Many embodiments of the invention will preferably use a hardwire connection, as wireless transmission may be deemed undesirable. Where the link is a hardwire connection, the hardwire connection may use any one of a variety of protocols, components, and transmission media, including Ethernet, copper wire, fiber optic, and so forth. Where the link is a wireless connection, the wireless connection may use any one of a variety of protocols and components, including Bluetooth, 802.11, lasers, radio frequency communication, etc.

The term “scan” as used in this written description refers generally to the act of moving a sensor relative to an object in order to collect data from the object. In general, an object can be scanned by moving the sensor in a variety of directions and orientations relative to the object and collecting data in one or more discrete units such as individual camera “frames” or images. However, the more particular concept of a “single scan” refers to a scan in which a contiguous, non-overlapping data set is collected in relation to the object by moving the sensor in a single connected motion. For instance, in a single scan along the length of a vehicle undercarriage, a sensor moves down the length of the undercarriage to collect a contiguous data set relative to the entire length of the vehicle.

FIG. 1 is a conceptual diagram of an under vehicle inspection system in accordance with one embodiment of the invention. Referring to FIG. 1, the under vehicle inspection system comprises a vehicle undercarriage inspection platform 101, one or more cameras or other sensors 102 associated with vehicle undercarriage inspection platform 101, and a data analysis element 103 adapted to receive, capture, and/or evaluate data obtained by sensors 102. In the illustrated embodiment, sensors 102 obtain data by moving with respect to the undercarriage of a stationary vehicle 100 parked on or parked over vehicle undercarriage inspection platform 101. A communications link 104 transmits data obtained by sensors 102 to data analysis element 103.

In one variation of the under vehicle inspection system shown in FIG. 1, sensors 102 are mounted within a camera carriage 105 which is mechanically associated with a camera carriage track 106. Camera carriage track 106 may take many different forms, but will usually be designed to provide precise control over the movement and/or positioning of camera carriage 105 in order to optimize use of sensors 102 in the collection of data. In addition, camera carriage track 106 will usually be designed to provide a smooth transportation mechanism for camera carriage 105 such as smooth surface for camera carriage 105 to move on and a drive mechanism that doesn't significantly vibrate camera carriage 105.

Several additional variations of the under vehicle inspection system of FIG. 1 are disclosed, as examples, in the '074 and '182 Applications. These variations illustrate the use of several different types of camera and camera carriage configurations, different vehicle undercarriage inspection platforms, data analysis elements, communications links, camera carriage tracks, and so on.

One notable feature of the embodiments illustrated in FIG. 1 and in the '074 and '182 Applications is that the sensors are typically located relatively close to the vehicle's undercarriage. For instance, where the sensors are mounted on top of the vehicle undercarriage inspection platform, the vertical distance between the sensors and the vehicle's undercarriage may be less than the ground clearance of the vehicle. The presence of a camera carriage between the platform and the sensors tends to decrease this vertical distance even further.

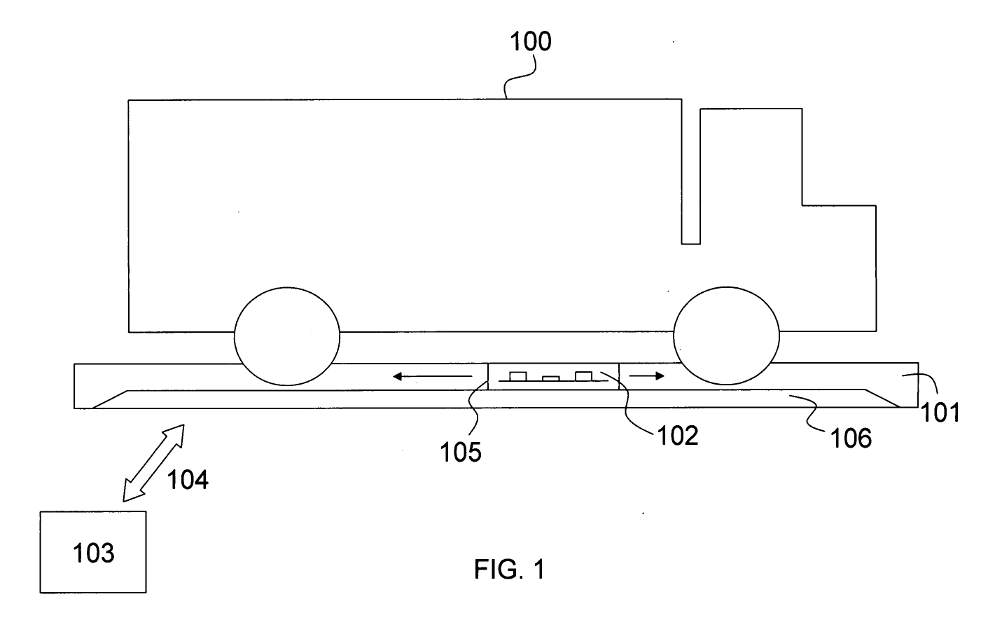

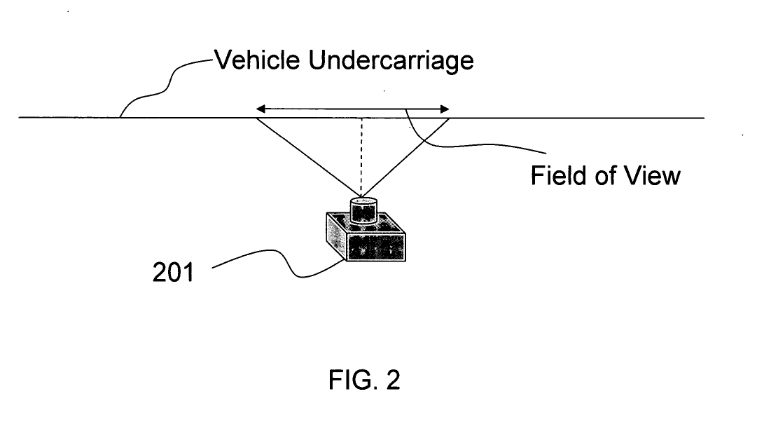

An example of such a sensor is illustrated in FIG. 2 of the drawings. In FIG. 2, a camera 201 is located on an under vehicle inspection platform beneath a vehicle undercarriage. The camera's optical axis is illustrated by a dotted line and the camera's field of view is illustrated by a pair of upwardly extending solid lines.

As illustrated by FIG. 2, the limited space between the vehicle undercarriage and the camera tends to limit the amount of the undercarriage that can be examined from the point of view of the camera. For example, the field of view of camera 201 only extends over a part of the vehicle undercarriage rather than the whole. Accordingly, it is unable to capture a full width image of the undercarriage in a single scan.

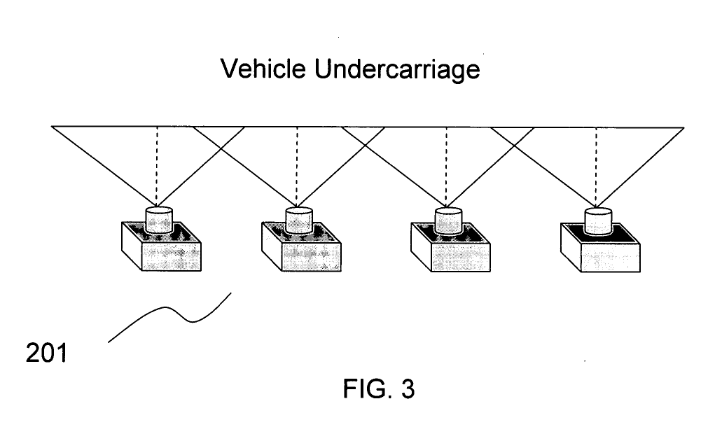

Because a thorough examination of the undercarriage requires that the whole undercarriage be scanned, a full width image is often obtained by using multiple cameras or by scanning the undercarriage in multiple directions, e.g., forward and back and side to side, using a single camera. An example of a system where multiple cameras are used to image the undercarriage of a vehicle is shown in FIG. 3 in which cameras 201 are aligned so that their field of views overlap enough so that a full width image of the vehicle undercarriage can be captured in a single scan.

Unfortunately, the above ways of addressing the problem add to the complexity, cost, and time required to capture images of the undercarriage. In addition, they also lead to complications in processes for analyzing captured images. For example, using multiple cameras increases the upfront cost and complexity of designing, constructing, and operating the system, both mechanically and logically. Furthermore, when images are captured using multiple cameras, the images cannot be readily analyzed as an integrated whole without performing some intermediate step of integration to relate the multiple images to each other. Examples of the intermediate integration step include techniques such as “image stitching” whereby multiple images of overlapping adjacent regions are aligned with each other and then joined to form a single composite image. Unfortunately, techniques such as image stitching tend to introduce a significant amount of computational overhead, they can produce inaccurately aligned images, they involve redundant data gathering, and perhaps most significantly, they often produce artifacts such as blur at the borders where the images are joined. Such artifacts can produce uncertainty and error in the process of analyzing the images.

Similar problems are also encountered when a single camera captures images by scanning the undercarriage in multiple directions. In particular, like multi-camera approaches, multiple directional scans generally produce a collection of images that can only be analyzed as a whole after performing some intermediate step of integration. Moreover, moving a camera in multiple directions tends to complicate the mechanical design of the under vehicle inspection system, slow down the image capture process, and can even lead to degraded image quality due to mechanical jitter introduced by the additional camera movements.

Because of the general cost, complexity, and inefficiency of capturing and analyzing multiple images using multiple cameras or multi-directional scans, it is desirable to be able to capture and analyze a single image of a vehicle undercarriage using a single camera and a single scan. However, as described above, full width images of an entire vehicle undercarriage cannot be captured by a single camera and a single scan if the camera's field of view of the undercarriage is overly contracted due to the limited vertical distance between the camera and the undercarriage.

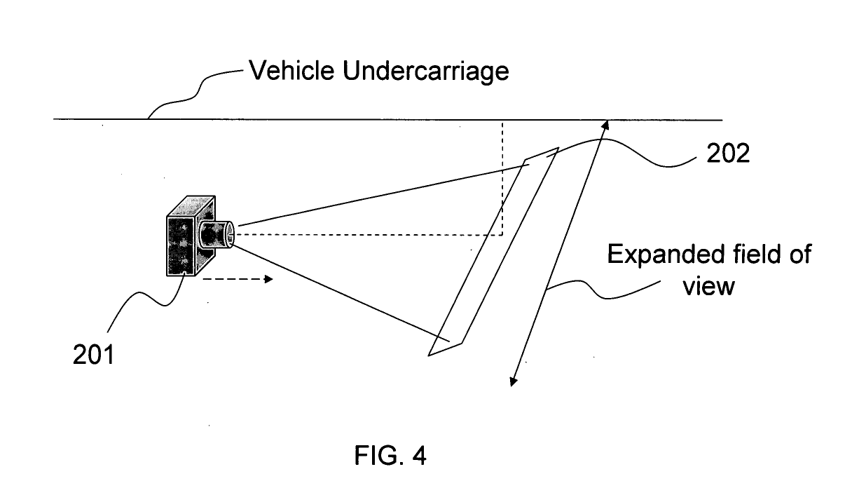

To address this problem, selected embodiments of the invention effectively increase the camera's field of view relative to the vehicle undercarriage by extending the “viewing distance” between the camera and the vehicle undercarriage as measured along the camera's optical axis. For example, FIG. 4 illustrates an under vehicle inspection system where camera 201 is oriented in relation to an adjustable mirror 202 such that its field of view extends across the whole width of the vehicle. As illustrated by the broken line, the optical axis of camera 201 in FIG. 4 is extended relative to the optical axis of camera 201 in FIGS. 2 and 3, and the field of view of camera 201 is extended accordingly. Because the field of view of camera 201 extends across the whole width of the vehicle, the under vehicle inspection system shown in FIG. 4 can capture a full width image of the entire undercarriage in a single scan by moving camera 201 and mirror 202 along the length of the vehicle in a direction indicated by a broken arrow. In some embodiments of the invention, camera 201 comprises a digital line scan camera adapted to gradually capture the full width image of the entire undercarriage as it scans the length of the vehicle at a substantially constant rate.

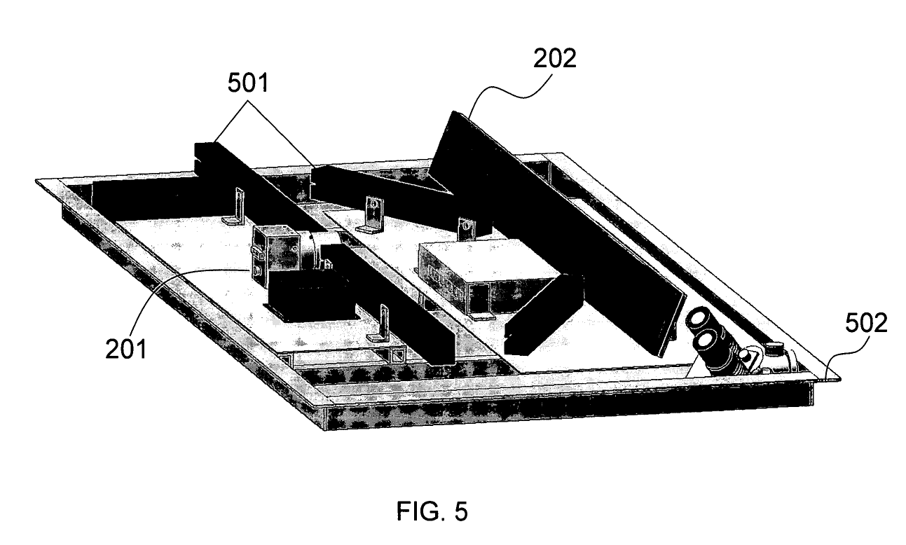

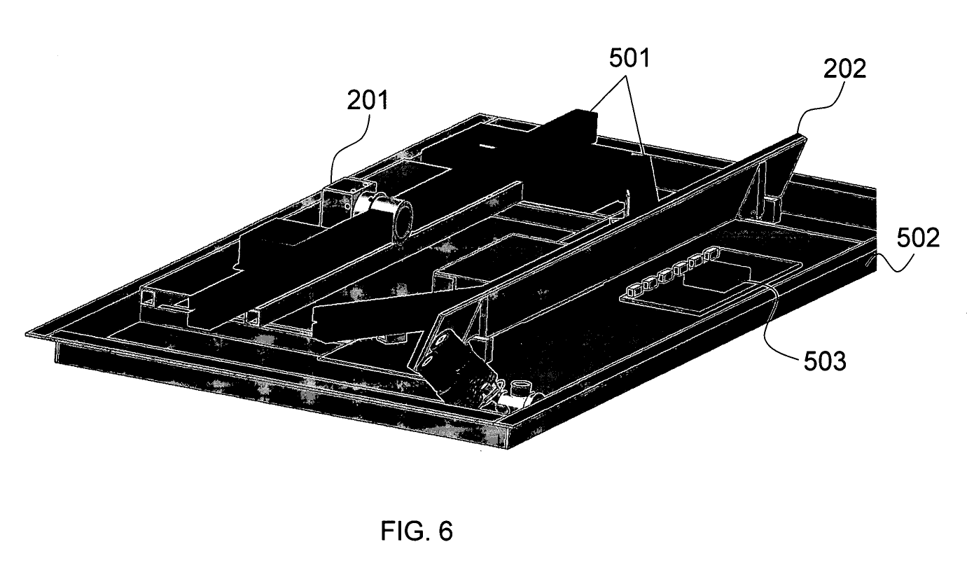

FIGS. 5 and 6 illustrate a more particular implementation of the vehicle undercarriage inspection system shown in FIG. 4. In FIGS. 5 and 6, camera 201 and mirror 202 are mounted in a camera carriage 502. Camera carriage 502 is designed to carry camera 201, mirror 202, and other associated components such as lights 501 and processing elements 503, during scans of a vehicle undercarriage. Examples of other components that could be included in camera carriage 502 are described in the '182 Application. It should be noted that other components such as lights 501 may also make use of mirror 202 to illuminate certain areas of the vehicle undercarriage for camera 201. Alternatively, however, lights 501 may illuminate the vehicle undercarriage directly.

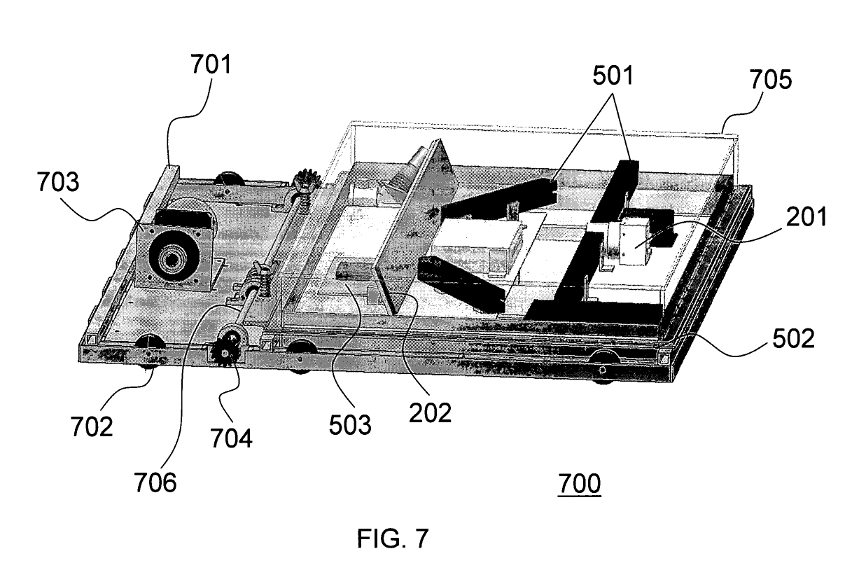

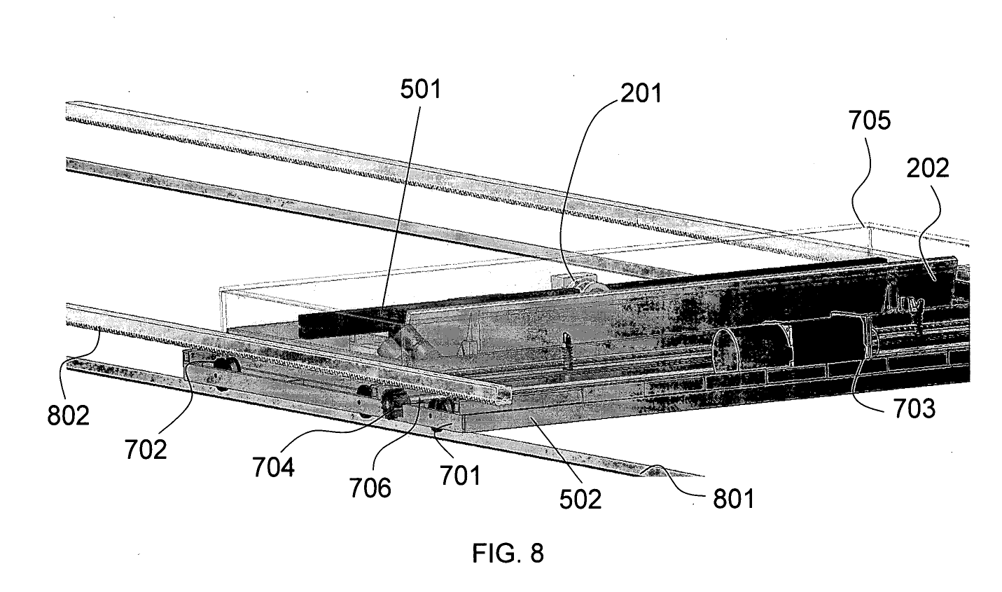

FIGS. 7 and 8 illustrate camera carriage 502 mounted on a motor plate 701. Motor plate 701 is designed to provide camera carriage 502 with controlled movement. Although motor plate 701 and camera carriage 502 are illustrated as separate features, they could also be formed together as an integrated camera carriage unit. Collectively, motor plate 701 and camera carriage 502 will be referred to as camera carriage unit 700.

Motor plate 701 rests on a plurality of v-groove wheels 702 designed to move smoothly along a camera carriage track 801. Camera carriage track 801 typically has a shape complementary to v-groove wheels 702 so that camera carriage unit 700 can rest stably and move smoothly thereon. Motor plate 701 includes a stepper motor 703 connected to an axle 706 by a belt (not shown) so as to drive axle 706. Helical pinion gears 704 are attached to both sides of axle 706 to drive motor plate 701 by engaging in a helical gear rack 802.

Because camera carriage 502 moves along camera carriage track 801 under the control of stepper motor 703, the rate of the camera carriage's movement can be controlled with a relatively high degree of precision. This precisely controlled movement helps camera 201 to accurately capture an image of the vehicle undercarriage as camera carriage 502 moves. For instance, where camera 201 comprises a digital line scan camera, the precisely controlled movement of camera carriage 502 can be used to determine the rate at which camera 201 captures each line of an image of the vehicle undercarriage.

In FIGS. 7 and 8, a transparent case 705 is placed over the components in camera carriage 502 to protect the components against external environmental factors such as debris, wind, harsh temperatures, and so on. However, transparent case 705 is not essential to the operation of camera carriage 502.

Because camera 502 captures an image while camera carriage 502 and motor plate 701 are moving, the movement may potentially affect the quality of the captured image. For example, mechanical vibrations generated by stepper motor 703, or by interactions between v-groove wheels 702 and camera carriage track 801, or between pinion gears 704 and gear rack 802 can cause camera 201 or mirror 202 to vibrate, thus affecting the clarity of images captured by camera 201. In addition, the image quality can also be affected by mechanical vibrations introduced by external sources such as vibrations generated by a vehicle being scanned, vibrations in the ground beneath camera 201, or even environmental conditions such as wind.

Fortunately, several features of the embodiments illustrated in FIGS. 5 through 8 tend to minimize mechanical vibrations that might otherwise affect the quality of images produced by camera 201. For instance, because the weight of motor plate 701 and camera carriage 502 rests on v-groove wheels, their movement along camera carriage track 801 tends to be relatively smooth compared with other potential embodiments such as a system where a camera carriage is mounted on top of a gear rack and is driven along the gear rack by a set of pinion gears, as disclosed in the '182 Application. In the embodiment illustrated in FIGS. 7 and 8, the gear rack is instead located above camera carriage 502 and motor plate 701 to provide the camera carriage with movement without the drawback of supporting metal plate 701 on the gear rack's uneven surface. In addition, the rack and pinion system of FIGS. 7 and 8 uses helical gears rather than other types of gears such as spur gears because helical gears tend to engage more smoothly than most other types of gears, thus eliminating one more source of potential mechanical disturbance.

Vibrations of mirror 202 can be further minimized through the use of a vibration free mirror mounting assembly. In addition, the position of mirror 202 can be adjusted to optimize the view of camera 201. Such adjustments can be made either manually or by manipulating some electromechanical apparatus such as a motor.

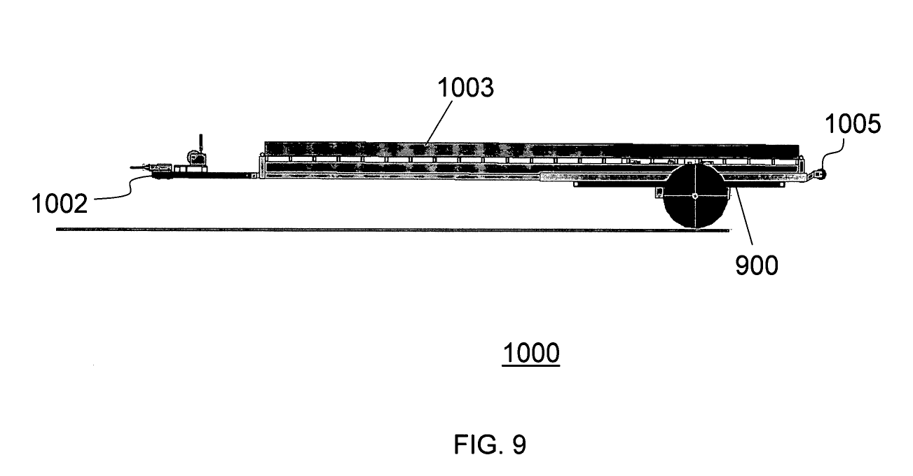

FIGS. 9 through 24 illustrate various embodiments of a vehicle undercarriage inspection platform adapted to support camera carriage 502 and motor plate 701 during vehicle undercarriage inspections.

Referring to FIG. 9, a vehicle undercarriage inspection platform 1000 comprises a tongue assembly 1002, scanning platform 1003 and a wheel/axel assembly 900. The tongue assembly 1002 is attached to scanning platform 1003 during transportation and is used for towing scanning platform 1003. Scanning platform 1003 includes a center portion adapted to support the camera carriage 502 and motor plate 701 and left and right wheel channels designed to receive and support a vehicle for inspections.

During transportation, tongue assembly 1002 is typically connected to the scanning platform 1003 and wheel/axel assembly 900 is connected to scanning platform 1003. Fasteners such as a set of pins, hooks, or screws passing through the respective frames are generally used to connect tongue assembly 1002 to scanning platform 1003 and to connect scanning platform 1003 to wheel/axel assembly 900. When under vehicle inspections are performed, the fasteners are removed or released and tongue assembly 1002 and wheel/axel assembly 900 are separated from scanning platform 1003 so that scanning platform 1003 can rest on the ground. Similarly, tongue assembly 1002 is generally disconnected from scanning platform 1003 when under vehicle inspections are performed.

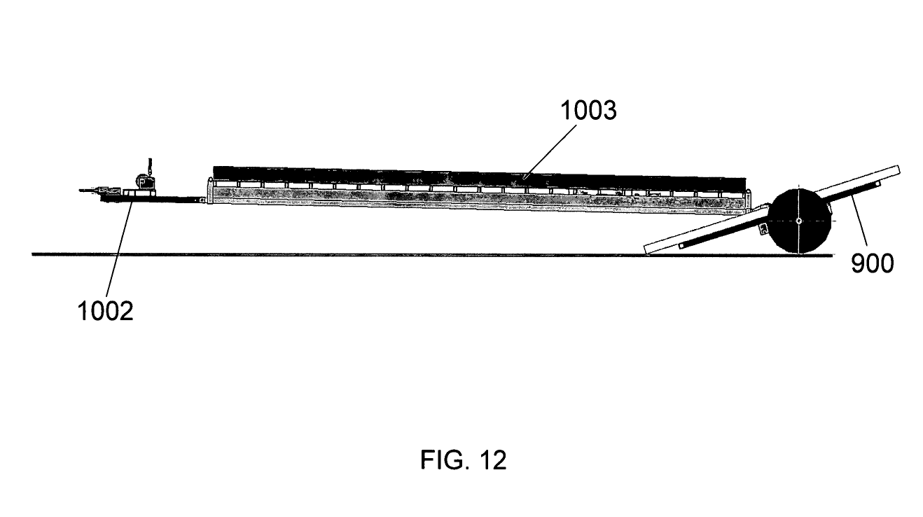

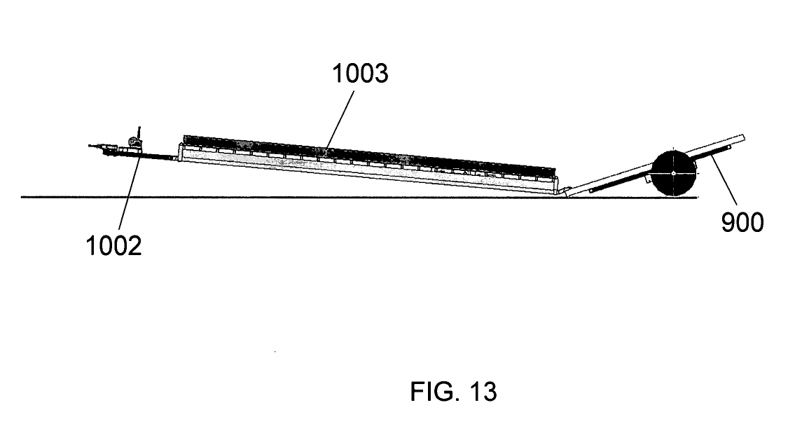

Scanning platform 1003 includes wheels 1005 used to help separate it from wheel/axel assembly 900. The wheels allow scanning platform 1003 to roll away from wheel/axel assembly 900 when the fasteners are unfastened, as illustrated in FIGS. 12 through 15.

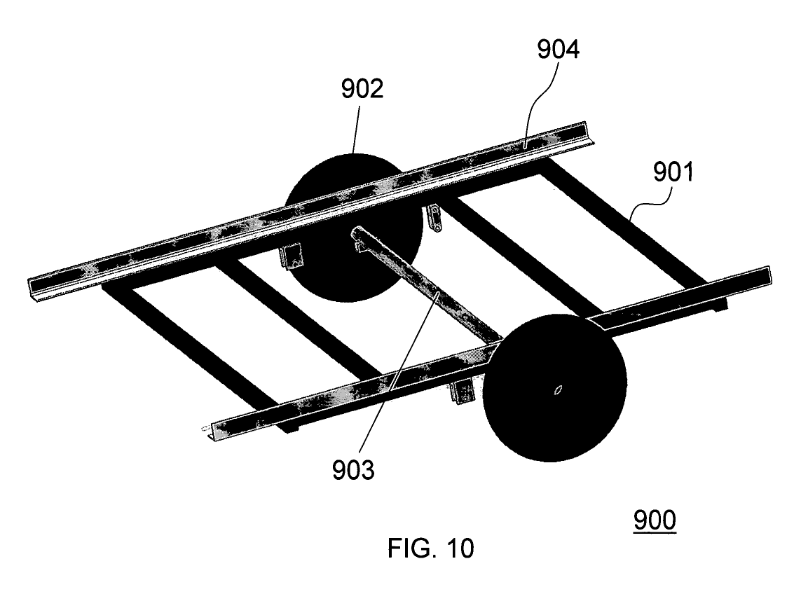

FIG. 10 shows wheel/axel assembly 900 by itself, separated from scanning platform 1003. Referring to FIG. 10, wheel/axel assembly 900 comprises a frame 901, wheels 902, and an axle 903. Frame 901 has gutters 904 adapted to receive and support scanning platform 1003 for transportation.

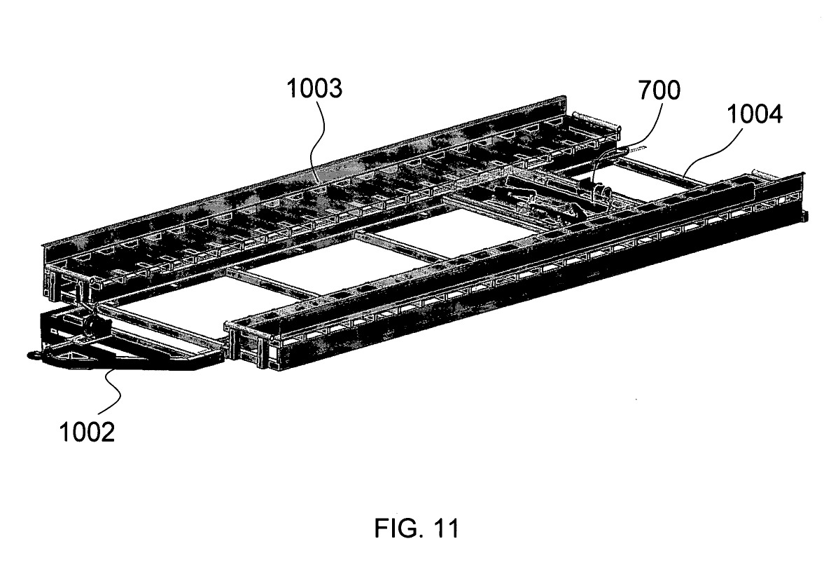

FIG. 11 shows tongue assembly 1002 and scanning platform 1003 separated from wheel/axel assembly 900. Scanning platform 1003 includes a frame 1004 whereon camera carriage track 801 and gear rack 802 are mounted. Camera carriage unit 700 is shown in FIG. 11 resting between camera carriage track 801 and gear rack 802.

When separated from wheel/axel assembly 900, scanning platform 1003 lays substantially flush with the ground and has a height of less than 0.3 meters (˜1 foot). This relatively low height of scanning platform 1003 is beneficial for a variety of reasons. For example, it contributes to the efficiency and safety with which vehicles can be driven onto scanning platform 1003 and it also contributes to the stability of scanning platform 1003 itself.

FIGS. 12 through 15 illustrate how tongue assembly 1002 and scanning platform 1003 can be separated from wheel/axel assembly 900 to place scanning platform 1003 on the ground for under vehicle inspections. Although not shown in the drawings, it is assumed that under vehicle inspection system 1000 is attached to a tow vehicle via tongue assembly 1002 during the process illustrated in FIGS. 12 through 15.

Referring to FIG. 12, the tow vehicle is parked, and wheels 902 of wheel/axel assembly 900 are choked or stabilized so that they cannot move. The fasteners connecting tongue assembly 1002 and scanning platform 1003 with wheel/axel assembly 900 are removed so that tongue assembly 1002 and scanning platform 1003 can be separated from wheel/axel assembly 900. The tow vehicle then moves forward so that wheels 1005 of scanning platform 1003 roll down gutters 904 of wheel/axel assembly 900 until they reach the ground, as shown in FIG. 13. Once wheels 1005 reach the ground as illustrated in FIG. 13, wheel/axel assembly 900 can be disconnected from scanning platform 1003.

Referring to FIGS. 14 and 15, tongue assembly 1002 is used to lower a front portion of scanning platform 1003 to the ground. Once scanning platform 1003 is substantially flush with the ground, tongue assembly 1002 can be disconnected from scanning platform 1003.

The processes of preparing vehicle undercarriage inspection platform 1000 for under vehicle inspections and of reassembling undercarriage inspection platform 1000 after under vehicle inspections can generally be performed in a matter of minutes (e.g., ˜15 minutes) with minimum manpower. Accordingly vehicle undercarriage inspection platform 1000 provides the convenience that may be required to quickly set up an inspection point in either an ad hoc or a permanent location.

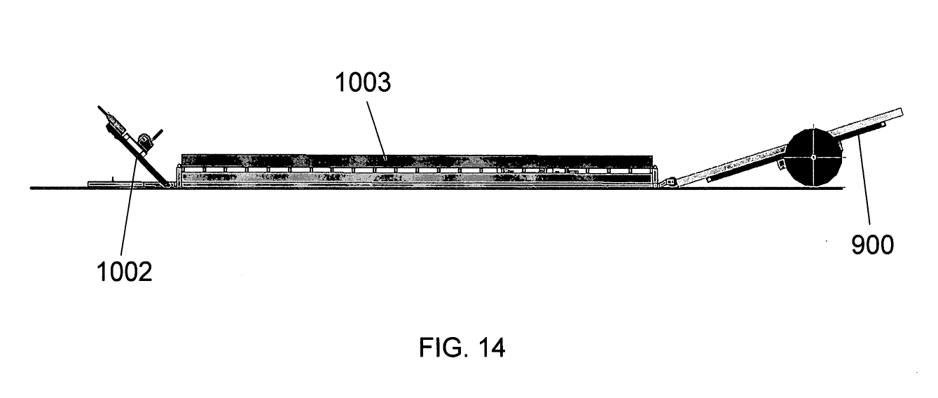

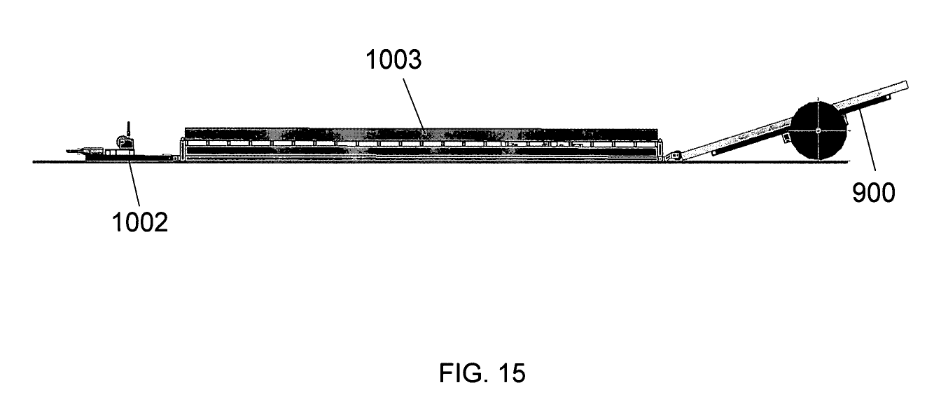

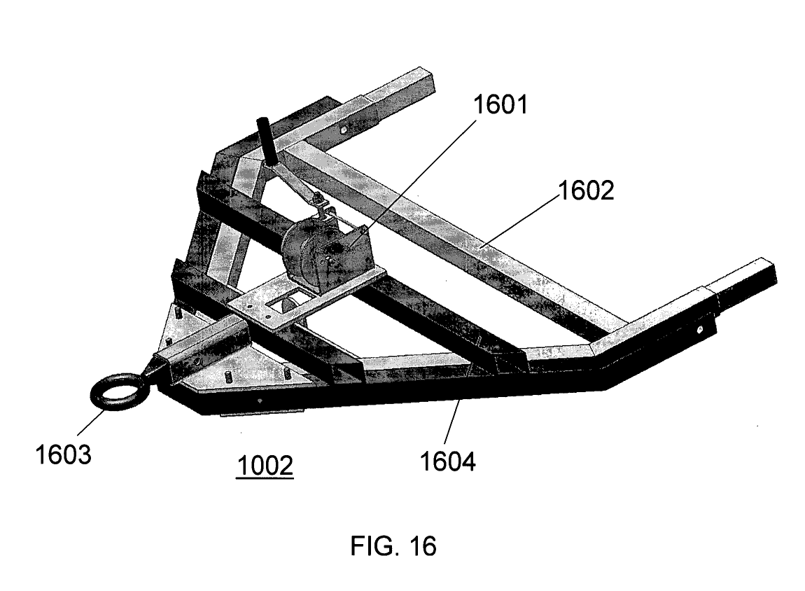

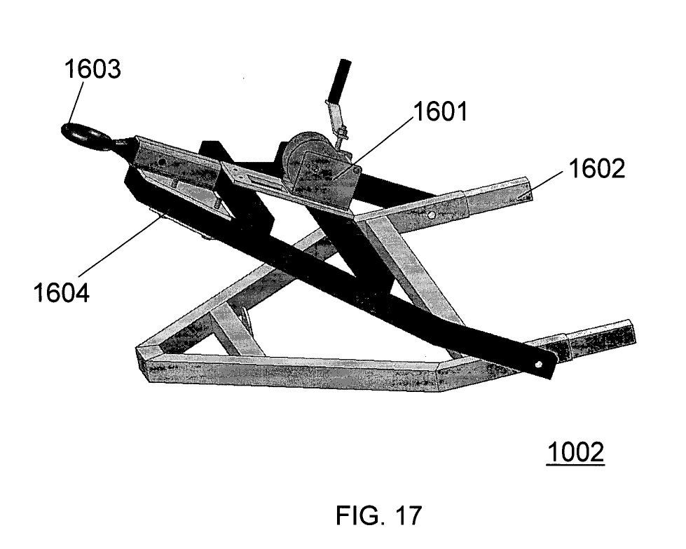

FIGS. 16 and 17 illustrate tongue assembly 1002 in further detail. As shown in FIGS. 16 and 17, tongue assembly 1002 comprises a first part 1602 connected by hinges to a second part 1604. First part 1602 includes a coupling element 1603 for connecting tongue assembly 1002 to a trailer hitch on the tow vehicle and a hand winch device 1601 for separating first part 1602 from second part 1604 to lower the front of scanning platform 1003 to the ground.

During transportation of under vehicle inspection system 1000, first part 1602 is generally connected to second part 1604 by a fastener such as a pin, hook, or screw. In order to lower the front of scanning platform 1003 to the ground, the fastener must be released or removed. Once the fastener is removed, the front of scanning platform 1003 can be lowered to the ground by operating hand winch device 1601 so that first portion 1604 rotates down away from second portion 1602. Once the front of scanning platform 1003 reaches the ground, coupling element 1603 can be disconnected from the trailer hitch of the tow vehicle and then tongue assembly 1002 can be disconnected from scanning platform 1003.

The steps illustrated in FIGS. 12 through 15 can be performed in reverse order to prepare under vehicle inspection platform 1000 for transportation after under vehicle inspections have been performed. For example, tongue assembly 1002 can first be reconnected to scanning platform 1003 and coupling element 1603 can be reconnected to the trailer hitch of the tow vehicle. Then, the front of scanning platform 1003 can be raised from the ground by operating hand winch device 1601 so that first portion 1604 rotates up towards second portion 1602. Next, scanning platform 1003 can be loaded onto wheel/axel assembly 900 by backing up the tow vehicle so that the wheels 1005 of scanning platform 1003 go up the gutters 904 of wheel/axel assembly 900. Finally, once fasteners have been applied to secure various parts of under vehicle inspection platform 1000 together, wheels 902 of wheel/axel assembly 900 can be un-choked, leaving under vehicle inspection platform 1000 ready for transportation.

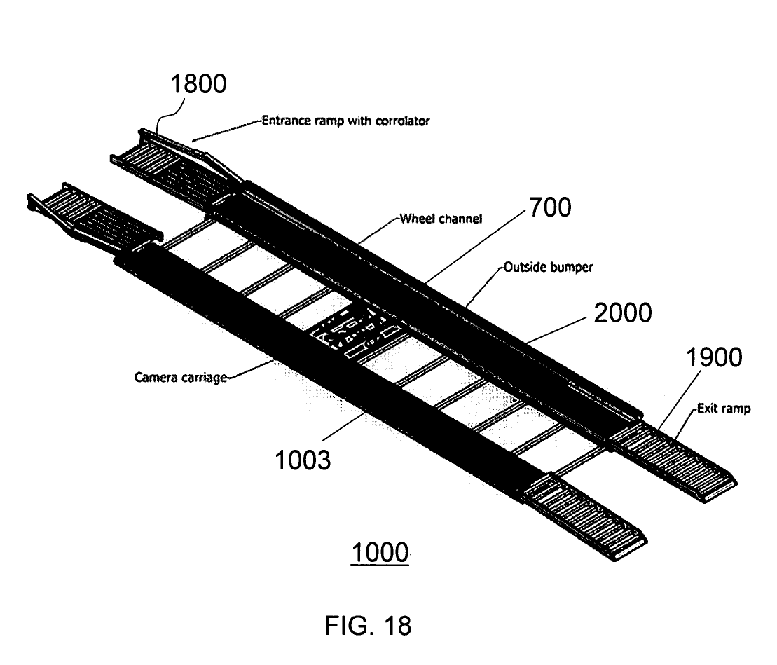

FIGS. 18 through 24 illustrate various features that can be used to help vehicles enter and exit under vehicle inspection platform 1000. In particular, these figures illustrate entrance and exit ramps designed to help vehicles mount and dismount from under vehicle inspection platform 1000 and a bumper system designed to help position the vehicles during the mounting and dismounting.

FIG. 18 illustrates an embodiment of under vehicle inspection system 1000 including entrance ramps 1800, exit ramps 1900, and a bumper system 2000. In FIG. 18, entrance and exit ramps 1800 and 1900 are shown in a position to allow vehicles to enter and exit scanning platform 1003. However, these ramps are preferably fold out ramps that are connected by hinges to scanning platform 1003 so that they can be folded onto scanning platform 1003 during transportation. When unfolded, exit and entrance ramps 1800 and 1900 both preferably have a grade of around 5%, which is a highway standard.

Bumper system 2000 includes bumpers on entrance ramps 1800 and scanning platform 1003. The bumpers include rollers designed to help center vehicles on scanning platform 1003 and to prevent the vehicles from driving off the edge of the ramps or scanning platform 1003 or into the center section where camera carriage unit 700 is located. The bumpers essentially form barriers for containing vehicles, and the rollers function to make it more difficult for vehicles to climb over the barriers. Although bumper system 2000 is shown to include bumpers only on outsides of scanning platform 1003, bumper system 2000 could include additional bumpers, for example, on the insides of the left and right vehicle support platforms of scanning platform 1003. Such additional bumpers, although optional, could be used, for instance, to more precisely position, guide, or secure a vehicle.

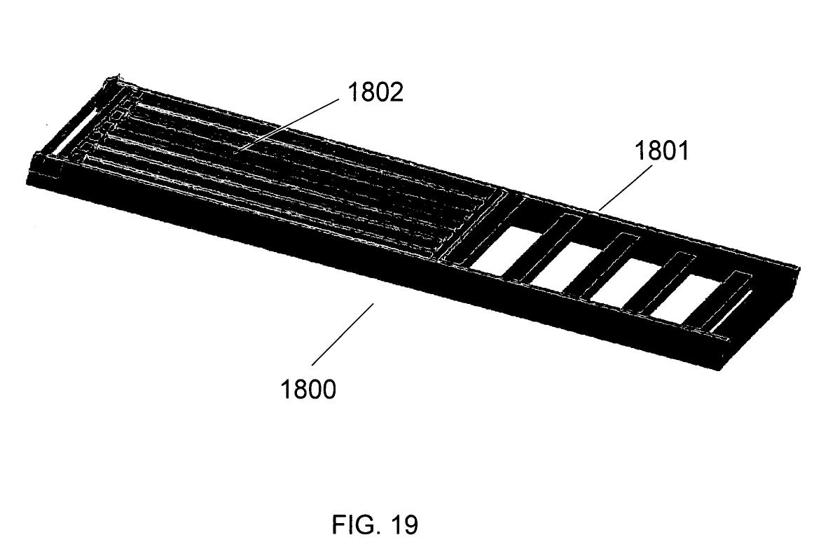

FIG. 19 shows a more detailed illustration of one of entrance ramps 1800. Referring to FIG. 19, each of entrance ramps 1800 comprises a frame 1801, which is big enough to receive one or more wheels and a set of correlating rollers 1802. Correlating rollers 1802 function together with bumper system 2000 to center vehicles on entrance ramps 1800 and scanning platform 1003 as the vehicles drive up entrance ramps 1800. Correlating rollers 1802 allow the wheels of a vehicle to move side to side for precise positioning, similar to the way that correlating rollers function to position a vehicle in a car wash.

In addition to providing safety, such precise vehicle positioning can also be useful for under vehicle inspection purposes. For example, if a vehicle is precisely positioned on under vehicle inspection platform 1000, an image taken of the vehicle's undercarriage can be readily compared with previous scans of the same vehicle or vehicles of the same make that were taken with the vehicle in approximately the same position.

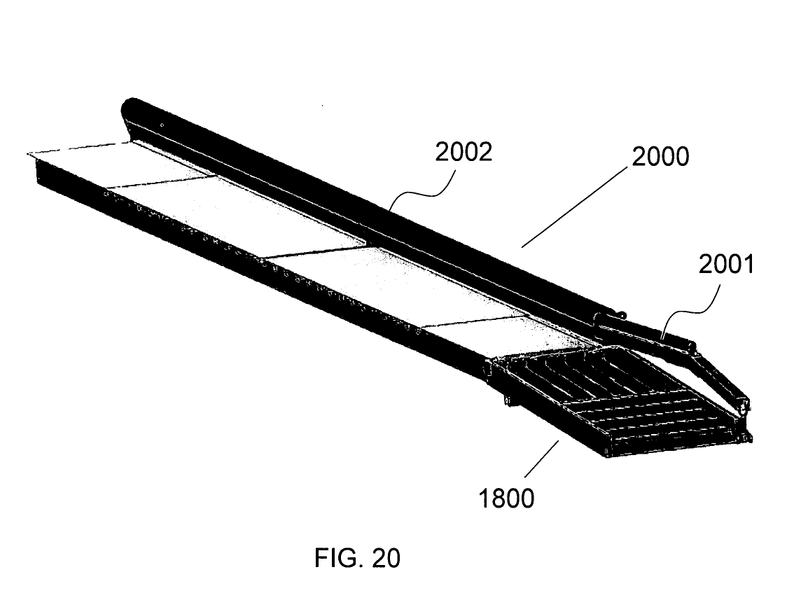

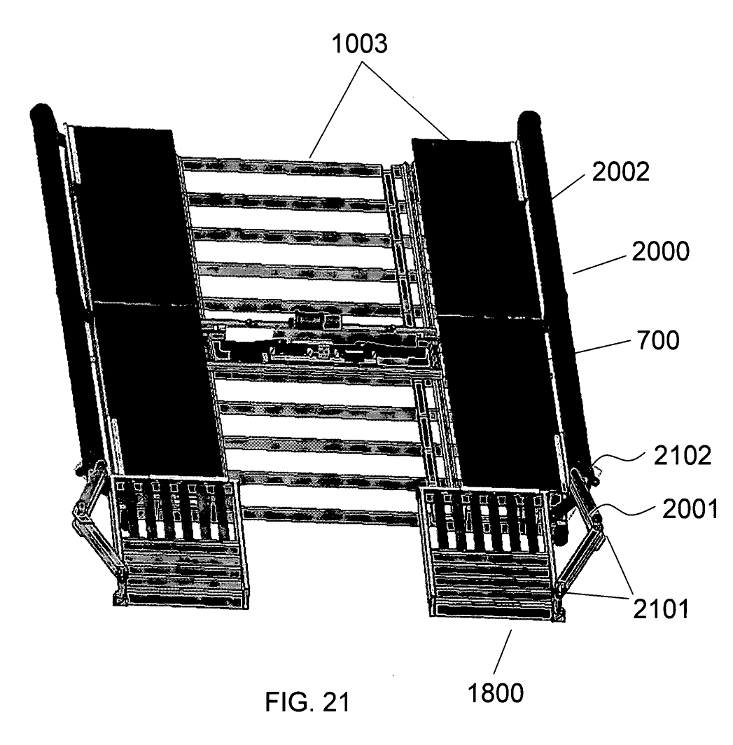

FIGS. 20 and 21 show entrance ramps 1800 and scanning platform 1003 together with bumper system 2000. Referring to FIGS. 20 and 21, bumper system 2000 includes outside bumpers 2001 located adjacent to entrance ramps 1800 and inside bumpers 2002 located adjacent to scanning platform 1003. Each of outside bumpers 2001 includes hinges 2101 allowing it to move in and out to position a vehicle entering scanning platform 1003, and each of inside bumpers 2002 includes swiveling mounts 2102 allowing it to move in and out together with outside bumpers 2001. As an example, the bumpers in bumper system 2000 are shown in an “IN” position in FIG. 20 and they are shown in an “OUT” position in FIG. 21.

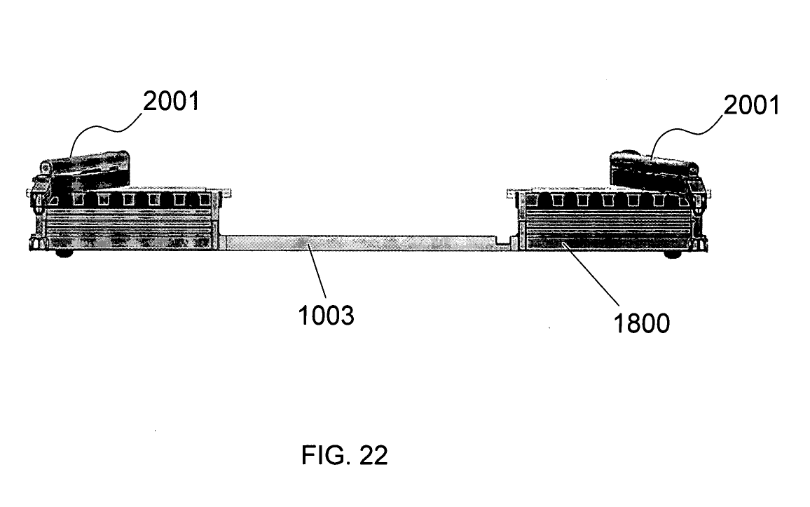

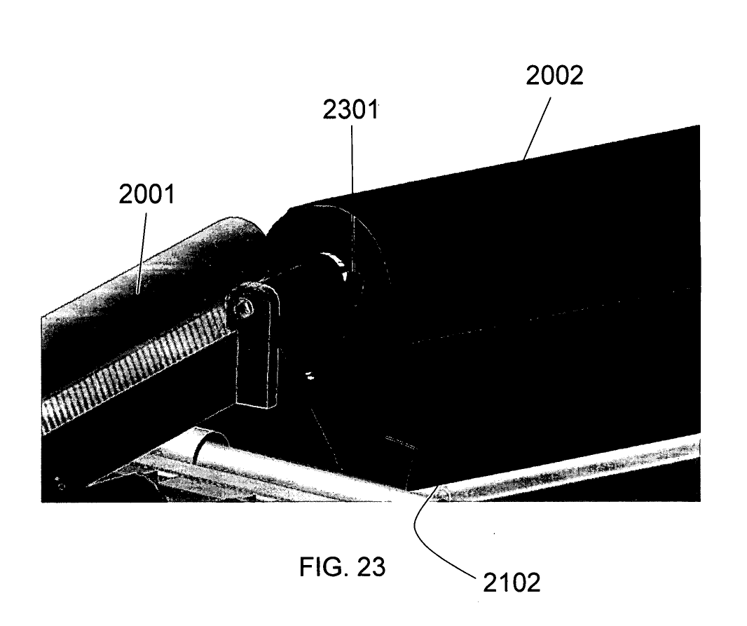

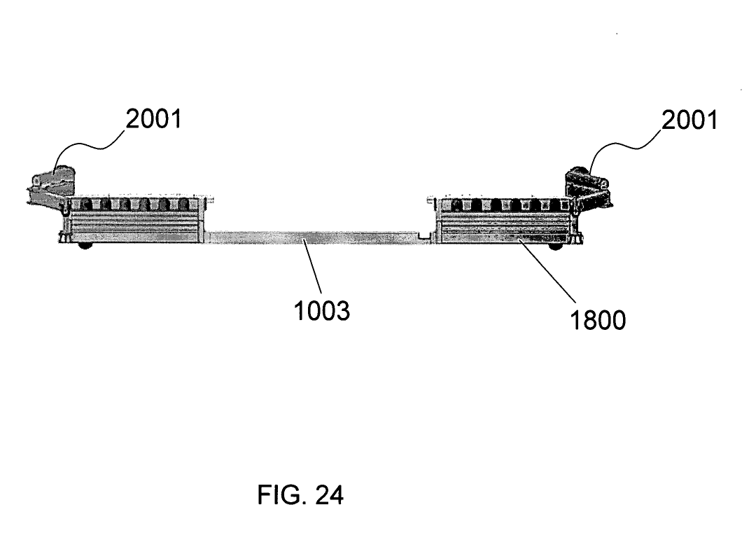

FIGS. 22 through 24 illustrate how outside bumpers 2001 work to help position a vehicle entering onto scanning platform 1003 via entrance platforms 1800. In particular, FIG. 22 illustrates a front view of under vehicle inspection platform 1000 with outside bumpers 2001 in the “IN” position before a vehicle enters scanning platform 1003. FIG. 23 illustrates a switching mechanism used to trigger the movement of inside and outside bumpers 2002 and 2001. FIG. 24 illustrates a front view of under vehicle inspection platform 1000 with inside and outside bumpers 2002 and 2001 in a final “OUT” position after a vehicle enters scanning platform 1003.

Referring to FIGS. 22 and 23, inside and outside bumpers 2002 and 2001 are initially in the “IN” position when a vehicle approaches entrance ramps 1800. They remain in the “IN” position until a vehicle simultaneously puts pressure on outside bumpers 2001 on both the left and right sides of under vehicle inspection platform 1000. Each of outside bumpers 2001 is designed to close a switch 2301 in response to pressure from a tire. Where the switches 2301 associated with the left and right outside bumpers 2001 are both closed at the same time, a hydraulic mechanism allows the inside and outside bumpers 2002 and 2001 to move to toward the “OUT” position as illustrated, for example, in FIG. 24 in order to guide the vehicle onto scanning platform 1003. Inside and outside bumpers 2002 and 2001 do not necessarily move into a complete “OUT” position, but instead may move into an intermediate position according to a tire width of the vehicle. In other words, the positioning of inside and outside bumpers 2002 and 2001 can be controlled in a variety of ways to control the positioning of the vehicle and/or to maintain the vehicle securely on scanning platform 1003.

Although various under vehicle inspection systems described above allow a single camera to take a full width image of a vehicle in a single scan, it is possible that certain areas of the vehicle's undercarriage will not be observable from the single camera's viewpoint. For example, certain parts of the vehicle under carriage may block the view of other parts of the vehicle undercarriage. A variety of solutions can be used to address this problem. For instance, the camera could be moved to different locations to adjust its viewpoint. Alternatively, more cameras could be used to view different parts of the vehicle undercarriage.

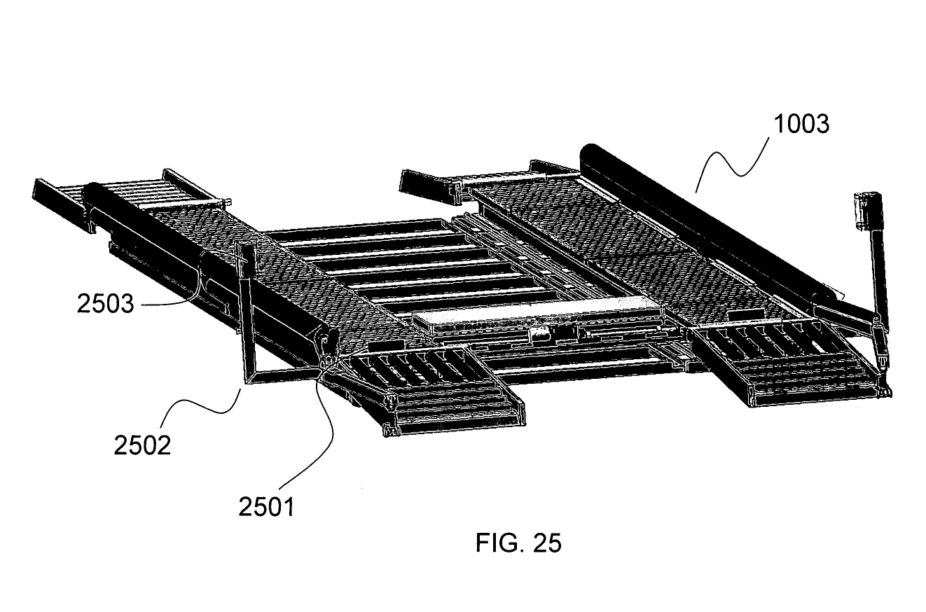

As an example, FIGS. 25 through 28 illustrate a wheel well inspection system that uses additional cameras attached to under vehicle inspection platform 1000 to inspect spaces in vehicles' wheel wells.

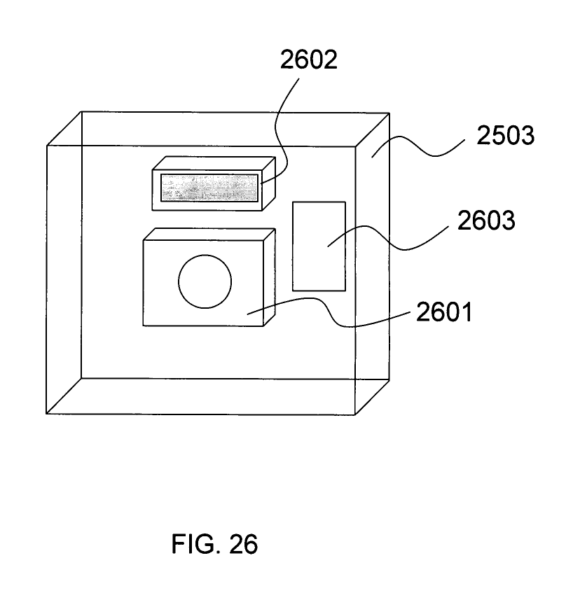

FIG. 25 is a diagram illustrating the wheel well inspection system in accordance with one embodiment of the invention. Referring to FIG. 25, the wheel well inspection system includes sensors 2501 located on entrance ramps 1800 or on the wheel channels of scanning platform 1003. Sensors 2501 are configured to detect the presence of a vehicle entering scanning platform 1003. Sensors 2501 are operatively connected to respective imaging units 2503, each of which includes a camera 2601 (See, FIG. 26) adapted to capture an image of the space within a wheel well of a vehicle. imaging units 2503 are connected to scanning platform 1003 by imaging unit mounts 2502. Typically, sensors 2501 comprise pressure sensors. However, in various embodiments, sensors 2501 can comprise any of a variety of other types of sensors such as motion detectors, magnetic sensors, and so on.

As a vehicle enters scanning platform 1003 for an inspection, the wheels of the vehicle will put pressure on sensors 2501. In response to the pressure from the wheels, sensors 2501 emit electrical signals to cause cameras 2601 in imaging units 2503 to capture images of the wheel wells near wheels. In other words, when the front wheels of the vehicle put pressure on sensors 2501, imaging units 2503 capture images of the vehicle's front wheel wells, and when the back wheels of the vehicle put pressure on sensors 2501, imaging units 2503 capture images of the vehicle's back wheel wells.

Usually, the electrical signals emitted by sensors 2501 are received in one or more controllers residing in one or both of imaging units 2503. The one or more controllers generally control the actuation of cameras 2601 and other electromechanical components associated with imaging units 2503. For example, in addition to cameras 2601, imaging units 2503 may also include moving parts such as motors used to adjust the location of cameras 2601 or imaging unit mounts 2503. Although the controller may be used to control various components automatically, any of these components could similarly be operated or adjusted under manual control. Further, although the controller is described as residing in imaging units 2503, the controller could also be located away from the imaging units, for example, in a device or system such as data analysis element 103 operatively connected to the under vehicle inspection system. Moreover, like other components in the under vehicle inspection system, the various intercommunicating components comprising the wheel well inspection system can communicate in a variety of ways, such as through a hardwire or a wireless connection.

FIG. 26 is a diagram illustrating one particular embodiment of an imaging unit 2503 used to capture images in the wheel well inspection system. Referring to FIG. 26, imaging unit 2503 comprises a controller 2603, camera 2601, and a flash 2602. Controller 2603 receives signals from sensors 2501 and controls camera 2601 and flash 2602 to capture an image in response to the signals. Controller 2603 typically controls camera 2601 to capture one or more still images in synchronization with flash 2602. Alternatively, camera 2601 could also capture a moving image.

At least two advantages of using camera 2601 to capture still images in conjunction with flash 2602 are first, by providing flash quality illumination, flash 2602 allows camera 2601 to view wheel wells clearly in a variety of different environments and natural lighting levels, and second, using flash 2602 tends to reduce blur that may occur as a result of camera 2601 capturing images as the vehicle is moving.

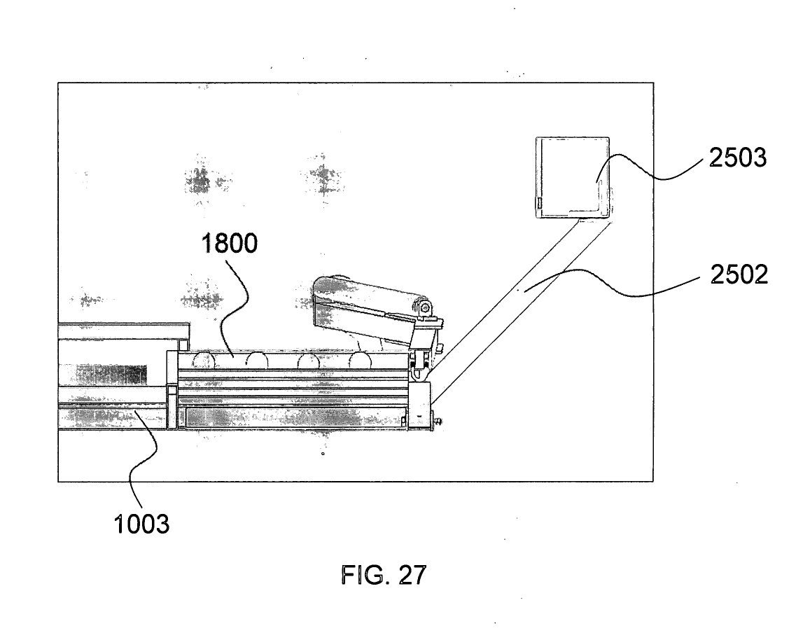

FIG. 27 is a front view illustrating the wheel well inspection system in further detail. As illustrated in FIG. 27, imaging unit mounts 2502 can be connected to the frame of scanning platform 1003 or to entrance ramps 1800 so that imaging unit 2503 extends above scanning platform 1003, providing cameras 2601 with a view of the wheel wells of a vehicle. Although shown in a fixed position, some embodiments of the invention allow imaging unit mounts 2502 to be adjusted to change the position of imaging unit 2503. As indicated above, any such adjustments can be made either manually or according to some automated mechanism.

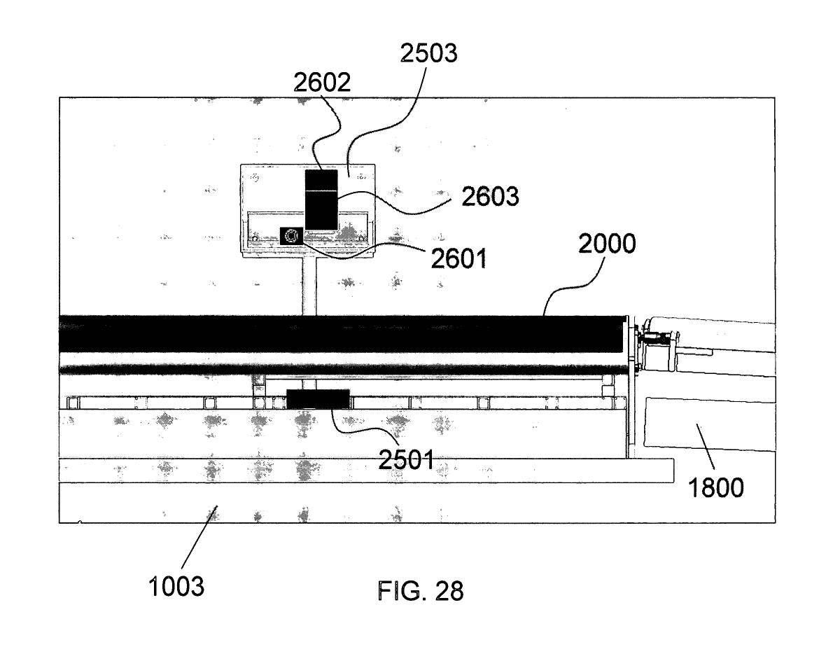

FIG. 28 is a side view illustrating the wheel well inspection system in further detail. As an example, FIG. 28 shows a conceptual illustration of sensor 2501 on scanning platform 1003. In the configuration illustrated in FIG. 28, sensor 2501 will be actuated when a vehicle's wheel wells are approximately centered on the field of view of imaging units 2503. As another example, FIG. 28 shows one configuration for camera 2601, controller 2603, and flash 2602.

The foregoing exemplary embodiments are presented as teaching examples related to the invention. Those of ordinary skill in the art will understand that various changes in form and details may be made to the exemplary embodiments without departing from the scope of the invention as defined by the claims that follow.

What is claimed:

1. An under vehicle inspection system, comprising:
a single camera adapted to capture a full width image of a vehicle undercarriage in a single scan;
wherein the camera has a viewing distance from the vehicle undercarriage, as measured along the optical axis of the camera, that is greater than a Euclidean distance between the camera and a point where the optical axis meets the vehicle undercarriage.

2. The system of claim 1, wherein the optical axis of the camera is deflected by a mirror.

3. The system of claim 2, wherein the mirror is mounted on a vibration reducing mounting assembly.

4. The system of claim 2, wherein the mirror can be adjusted to change the camera's view of the vehicle undercarriage.

5. The system of claim 2, wherein the camera and the mirror are mounted in a camera carriage adapted to move along the length of the vehicle undercarriage to perform the single scan.

6. The system of claim 5, wherein the camera carriage moves along the length of the vehicle undercarriage using a smooth movement mechanism.

7. The system of claim 6, wherein the smooth movement mechanism comprises:
v-groove wheels attached to the camera carriage and adapted to support and move the camera carriage along a smooth camera carriage track configured to mate with the v-groove wheels; and,
a drive mechanism adapted to move the camera carriage along the camera carriage track.

8. The system of claim 7, wherein the drive mechanism comprises:
pinion gears and an associated axel operatively connected to the camera carriage; and,
a stepper motor connected to the axel and adapted to move the pinion gears in a gear rack located above the camera carriage so as to move the camera carriage along the camera carriage track at a controlled speed.

9. The system of claim 8, wherein the pinion gears and axel are connected to the camera carriage via a motor plate.

10. The system of claim 5, further comprising:
a vehicle undercarriage inspection platform comprising a track adapted to support the camera carriage, wherein the vehicle undercarriage inspection platform comprises:
a tongue assembly, a scanning platform, and a wheel/axel assembly adapted to be connected during transportation of the system and separated during vehicle undercarriage inspections.

11. The system of claim 10, wherein the tongue assembly comprises a coupling element for connecting the vehicle undercarriage inspection platform to a trailer hitch on a tow vehicle, and the scanning platform comprises a camera carriage track adapted to support the camera carriage; and,
wherein the wheel/axel assembly comprises a frame, an axel attached to the frame, and wheels attached to the axel.

12. An undercarriage inspection platform for an under vehicle inspection system, the platform comprising:
a scanning platform comprising a camera carriage track adapted to support a camera carriage such that the camera carriage can move along the length of a vehicle to perform an under vehicle inspection;
a wheel/axel assembly comprising a frame, wheels, and axels and adapted to be connected to the scanning platform during transportation and detached from the scanning platform so that the scanning platform lays on the ground during under vehicle inspections.

13. The platform of claim 12, wherein the camera carriage track is adapted to mate with v-groove wheels used to support the camera carriage;
wherein the scanning platform further comprises a gear rack located above the camera carriage and adapted to engage a set of pinion gears operatively connected to the camera carriage to allow the camera carriage to move along the platform.

14. The platform of claim 12, wherein the scanning platform further comprises:
a bumper system comprising rollers adapted to control the position of a vehicle on the platform and to prevent the vehicle from leaving the platform.

15. A wheel well inspection system for an under vehicle inspection system comprising an under vehicle inspection platform, the wheel well inspection system comprising:
a sensor adapted to detect the presence of a wheel on the under vehicle inspection platform and generate an electrical signal in response to detecting the presence of the wheel; and,
an imaging unit adapted to capture an image of a wheel well of a vehicle in response to the electrical signal.

16. The system of claim 15, wherein the imaging unit comprises a camera and a flash actuated in response to the electrical signal to capture the image.

17. The system of claim 15, wherein the sensor comprises a pressure sensor.

18. The system of claim 15, wherein the imaging unit is attached to the under vehicle inspection platform by imaging unit mounts.

19. A method of inspecting the undercarriage of a vehicle, the method comprising:
moving a single camera along the length of the vehicle to capture a single full width image of the undercarriage;
wherein the camera has a viewing distance from the undercarriage, as measured along the optical axis of the camera, that is greater than a Euclidean distance between the camera and a point where the optical axis meets the undercarriage.

20. The method of claim 19, wherein the optical axis of the camera is deflected by a mirror.

21. The method of claim 20, further comprising adjusting the mirror to change the camera's view of the undercarriage.

22. The method of claim 20, wherein the camera and the mirror are mounted in a camera carriage, and moving the camera along the length of the undercarriage comprises moving the camera carriage.

23. The method of claim 22, wherein the camera carriage comprises v-groove wheels used to support and move the camera carriage along a smooth camera carriage track, and pinion gears adapted to engage in a gear rack located above the camera carriage; and,
wherein moving the camera along the length of the vehicle undercarriage comprises operating a stepper motor operatively connected to the pinion gears to move the pinion gears in the gear rack so that the camera carriage moves along the smooth camera carriage track.

24. The method of claim 19, further comprising:
operating a bumper system to position the vehicle in relation to an under vehicle inspection platform.

25. The method of claim 19, wherein operating the bumper system comprises:
moving a set of left and right outside bumpers from an “IN” position to an “OUT” position in response to simultaneous pressure from left and right tires of the vehicle on the respective left and right outside bumpers.
